(19) United States
(12) Patent Application Publication
(10) Pub. No.: US 2016/0293293 A1
(43) Pub. Date: Oct. 6, 2016

(54) Cable Management System

(71) Applicant: Axel Electronics Inc., Port Washington, NY (US)

(72) Inventors: Sam SangHoon Oh, Old Westbury, NY (US); Seunghee Oh, Roslyn Heights, NY (US); Ho Yong Chung, Flushing, NY (US); Kevin Oh, Old Westbury, NY (US)

(21) Appl. No.: 14/679,550

(22) Filed: Apr. 6, 2015

(51) Int. Cl. H01B 7/40; H01R 25/00; H01B 7/04

(52) U.S. Cl. CPC H01B 7/40; H01B 7/04; H01R 25/003

(57) ABSTRACT

A cable management system (10) for retaining cables that is an improvement in the management of cables (14) or other long flexible articles, particularly when gathered for storage. The cable management system may allow a cable retaining when wrapped as a coil or in bundle form. It may include an element integrated with one or both ends of the cable, so that the cable is integrated with the cable management system and cannot be physically separated from the cable or cord or lost. The cable management system may utilize a malleable element (20) oriented along an end of the cable, such that the malleable element may be bent into a position in which it is wrapped around a cable coil (130) or bundle (30).

### TECHNICAL FIELD

The present invention is generally related to a cable management system and more specifically it relates to a cable configured to be wrapped or tied in an organized and accessible way when not in use while eliminating the need to carry multiple cables or a dedicated device for cable management.

### BACKGROUND ART

Even in today's wireless technological environmental, user's of portable electronic devices rely on cables of various nature and purpose on a regular if not daily basis. As examples, a cable connects a user's headphones or earphones to a music player, a cable extends from a wall socket to charge a portable device's battery, or a cable provides data transmission between a portable device and a laptop or desktop computer. If a user leaves home without a cable, that user will eventually find himself or herself unable to use the wireless portable device to its full extent for one reason or another. Accordingly, users will typically carry with them, cables for audio output, for charging or power supply, and for data transmission. The increasing popularity and availability of portable electronic devices has resulted in an increasing demand for cable management solutions for such portable electronic devices.

Without a system to manage their cables, the various audio, charging, and data cables carried by a user tend to become tangled and disorganized. Untangling such cables every time a user wants to use one becomes both frustrating and time consuming. Moreover, a cable can become permanently knotted or otherwise damaged or inoperable due to this oft repeated treatment. Typically, the cables end up tangled or knotted after being unceremoniously dropped into the bottom of backpacks, briefcases and handbags.

Even in the case of a conscientious user who connects one end the cable to the device, meticulously twists and wraps a cable around itself or over the portable device, and uses the free end to attempt to secure the coiled cable, that user often finds himself soon after with a disorganized and tangled cable as the bundling or coiling of the cable is not retained. Further, keeping the cable connected to the device on one end can lead to premature failure of the cable or its connector due to the added stress on the cable end or its receptor that this process causes.

Alternately, the end of the coiled or bundled cable could be tied around the coil or bundle to keep the coil or bundle from uncoiling. In order to keep the end in place, a knot would typically be formed in the end of the cable to allow the cable end to be retained around the coiled or bundled cables. Such knots, however, may become difficult to untie, especially if the knot becomes over-tightened.

To avoid the inconvenience of carrying multiple cables, user's will also accumulate a plethora of cables, which are then inevitably left dangling from wall sockets, or from USB ports, or from lighter outlets in cars. In addition to being an added expense to purchase redundant cables, this solution is unseemly and cluttered in one's workspace, home or car. Unfortunately, having the cable connectors constantly attached to ports increases the chance that a cable connector or the port will get damaged if the cable is accidently yanked. Further, leaving a cable connector resting on the floor leaves it vulnerable to damage by being stepped on, rolled over by a chair, or other damaging but otherwise avoidable outcomes.

Solutions have included carrying additional items such as ties, reels, or spools, either to wrap around a cable, to wrap a cable around, or to attach to the cable to assist in wrapping the cable around itself. However, asking a user to remember and carry yet another item is not a satisfactory solution.

Therefore, it is readily apparent that there is a recognizable and unmet need for a cable management system and method of use for wrapping and tying a cable or the like, where the cable management system is integrated with the cable and, thereby, prevents the cable from becoming tangled and disorganized between uses, ready for a subsequent use with minimum risk of cord entanglement or separation of the cable management system from the cord.

### BRIEF SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

This disclosure addresses the above and other needs by providing a cable management system that gives a user the ability to transport and store electronic cables in an organized and convenient manner while avoiding the need to remember to carry and to use a separate device to retain or restrain its cables by providing a cable with an integral cable management system. The cable management system provides for a wrapped, tied, coiled, or bundled cable stored in an organized and accessible way when not in use while minimizing the need to carry multiple cables or a dedicated device for cable management.

In an embodiment, a cable management system includes a cable having comprising a flexible conductor, a first end and a second end, a cable axis extending from the first and second ends when the cable is tautly extended, a connector body coupled to the cable at the first end of the cable, and a malleable securing member integral with the connector body. A cable management system that when it is in a first position, the securing member is disposed to extend away from the connecter body in a direction adjacent to and generally parallel to the cable axis and when it is in a second position, the securing member is disposed to secure the cable by wrapping around overlapping lengths of the cable; and wherein the securing member retains its shape when manipulated by a user.

In another embodiment, a cable management system includes a cable having comprising a flexible conductor, a first end and a second end, a cable axis extending from the first and second ends when the cable is tautly extended, a connector body coupled to the cable at the first end of the cable, and a malleable securing member integral with the connector body. A cable management system that when it is in a first position, the securing member is disposed to extend away from the connecter body in a direction adjacent to and generally parallel to the cable axis and when it is in a second position, the securing member is disposed to secure the cable by wrapping around overlapping lengths of the cable; and wherein the securing member retains its shape when manipulated by a user.

In yet another embodiment, a cable management system includes a cable having a flexible conductor, a first end and a second end, and a cable axis extending from a first and second end when the cable is tautly extended. The cable management system may also have a connector body coupled to the cable at said first end of the cable; a securing member integral with the connector body and having at least a two pliable lengths. The first and second pliable lengths may be disposed on opposite sides of the cable axis and each extend away from the connecter body in a direction adjacent to and generally parallel to the cable axis in a first position. The first and second pliable lengths may be coupled to each other at point other than the attachment member and the securing member may be malleable and retain its shape when manipulated by a user. When in a first position, the securing member may be disposed to extend away from the connecter body in a direction adjacent to and generally parallel to the cable axis and when in a second position, the securing member may be disposed to secure the cable by wrapping around overlapping lengths of said cable.

### BRIEF DESCRIPTION OF THE DRAWINGS

The above and other aspects, features and advantages of the present invention will be more apparent from the following more particular description thereof, presented in conjunction with the following drawings. For the purpose of illustrating the invention, exemplary constructions of the invention are shown in the drawings. However, the invention is not limited to the specific methods and instrumentalities disclosed herein.

FIG. 1 is a front perspective view of the invention, with the cable management tab in an extended position.

FIG. 2 is an enlarged perspective view, taken from FIG. 1 as indicated, with the cable management tab in an extended position. Also shown are lettered arrows indicating examples of how the cable management tab can be manipulated by a user.

FIG. 3a-f are views from the front, rear, side, opposing side, top, and bottom respectively, of the cable management system as illustrated in FIG. 2 according to an embodiment of the invention. Also shown are lettered arrows indicating examples of how the cable management tab can be manipulated by a user.

FIG. 4 is a perspective view of the invention, with the cable management tab in use with a coiled cable.

FIG. 5a is a cross-sectional view of the invention insert taken generally on line 5A-5A in FIG. 3a. (Line 5A-5A passes through the wire manager tab (20) laterally at a point other than through the indents represented by 38a and 38b.)

FIG. 5b is a cross-sectional view of the invention insert taken generally on line 5B-5B in FIG. 3a. (Line 5B-5B passes through the wire manager tab (20) laterally through indents represented by 38a and 38b.)

FIG. 6 is a perspective view of another application of the invention, with the cable management tab in an extended position.

FIG. 7 is an enlarged perspective view, taken from FIG. 6 as indicated, with the cable management tab in an extended position. Also shown are lettered arrows indicating examples of how the cable management tab can be manipulated by a user.

FIG. 8a-f are views from the front, rear, side, opposing side, top, and bottom respectively, of the cable management system as illustrated in FIG. 7 according to an embodiment of the invention. Also shown are lettered arrows indicating examples of how the cable management tab can be manipulated by a user.

FIG. 9 is a perspective view of the invention shown in FIG. 6, with the cable management tab in use with a bundled cable.

Corresponding reference characters indicate corresponding components throughout the several views of the drawings.

### DETAILED DESCRIPTION OF THE DRAWINGS

While the invention herein disclosed has been described by means of specific embodiments and applications thereof, this description is not to be taken in a limiting sense, but is made merely for the purpose of describing one or more preferred embodiments of the invention. Numerous modifications and variations could be made thereto by those skilled in the art without departing from the scope of the invention set forth in the claims. The scope of the invention should be determined with reference to those claims.

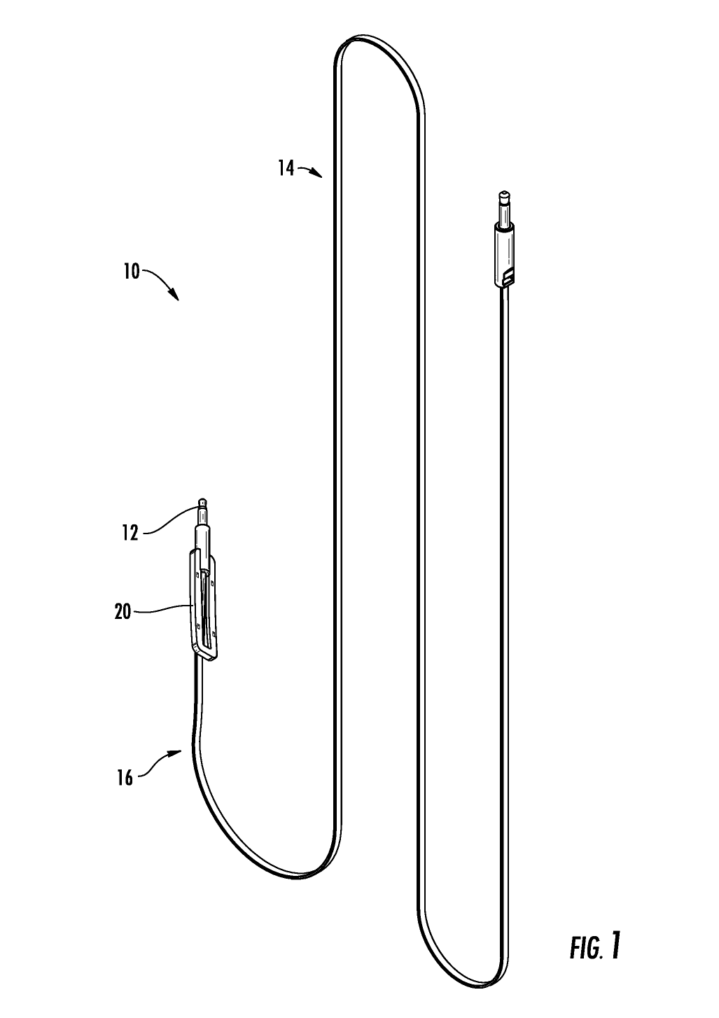

FIG. 1 is a perspective view of a cable management system 10. The cable management system 10 of FIG. 1 may be integral with a cable connector 12 which may be fixed to a cable 14 at an end of the cable 16.

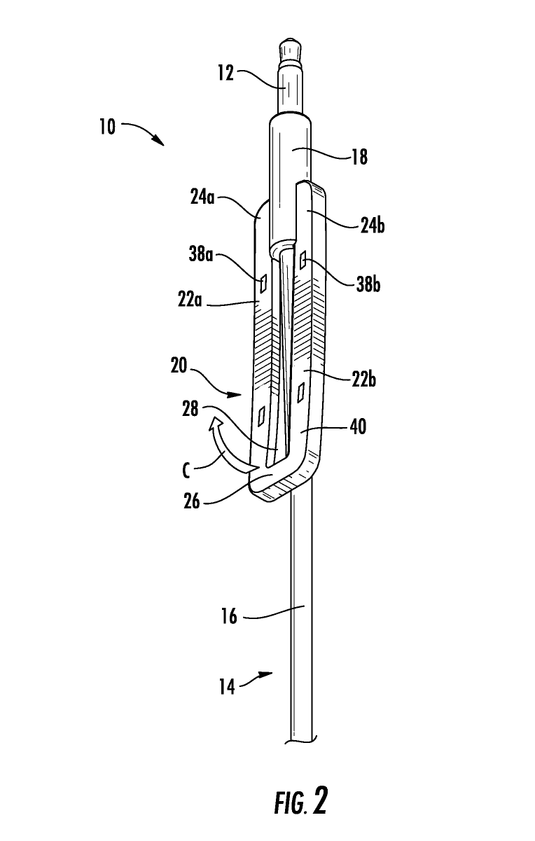

FIG. 2 is an enlarged perspective view of the cable end 16 illustrating the cable management system 10 in greater detail. The cable connector 12 may be housed in a connector housing 18. Extending from the connector housing 18 may be a malleable cable retainer 20. The cable 14 may a cable for use with any portable electronic device, which include MP3 and other music players or portable speakers systems, cell phones or smartphones and the like, and other rechargeable or internet enabled devices. However, cables for use with laptops, computer systems, audio/visual systems, or any other electronic devices are also considered. The cable 14 may be purposed for audio input/output, power supply, charging/recharging, data transmission or any other purpose for use with an electronic device. A cable 14 will typically have at least a conductive inner portion and a flexible, protective, and non-conductive outer sheath or layer.

The cable connector 12 may have a connection which is either a male or female jack or plug and is able to connect to an appropriate male or female opposite connection of a plug, jack, receptacle, or socket, of an electronic device or of another cable connector. For an example, for an audio connection (FIGS. 1-4), the connector may include a male 3.5 mm audio plug that can connect to either a jack in a smartphone for playing audio files or to an 3.5 mm input jack of headphones for listening to audio. Other audio connections or combinations of connections known in the art are also contemplated. The cable connector may be any other standardized or proprietary connector known in the art for use with any other standardized or proprietary cable in the art.

The cable retainer 20, which may be integral to a connector housing 18 of the cable connector 12, may be disposed on the connector housing 18 in a position to not interfere with a user's ability to connect the cable 14 with the cable connector 12. The cable retainer 20 may also be disposed to extend generally away from the cable connector 12 and positioned generally parallel and adjacent to the cable 14 at the cable end 16 when not in use to retain the cable 14. This positioning may help keep the retainer 20 out of a user's way and prevent it from getting snagged while a user is using the cable.

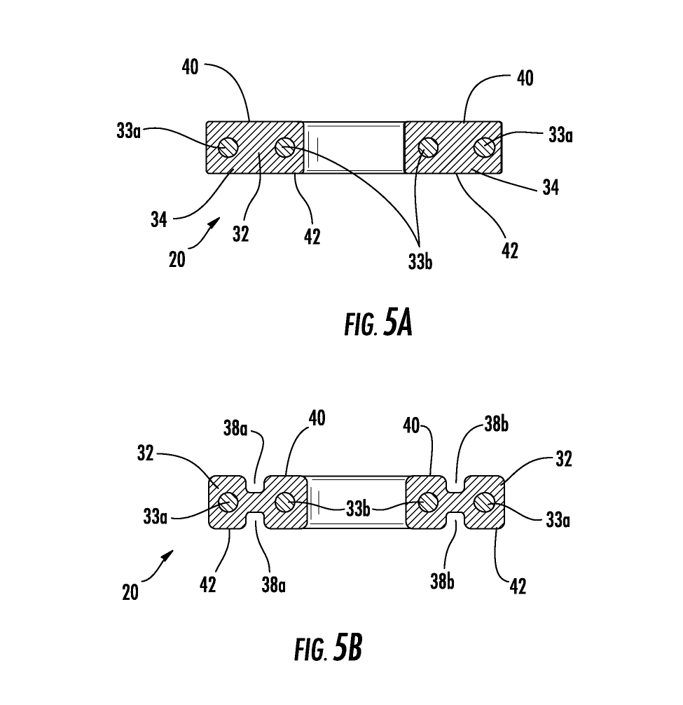

The retainer 20 may be a single pliable extension or length 22 having a single attachment point 24 on the connector housing 18. However the retainer 20 may comprise more than one pliable length 22 and have more than one attachment point 24 on the connector housing 18. In the embodiment illustrated in FIGS. 1-4, retainer 20 includes two length 22a,b which are attached to the connector housing 18 at two points 24a,b on the connector housing 18. In closer proximity to attachments points 24, the lengths may be more rigid, while the lengths may be more pliable further from the attachments points 24. Lengths 22a,b may have one or more dimples or recesses 38a,b on a front 40 or rear 42 facing surface of retainer 20, as illustrated in FIGS. 5a and 5b, and discussed infra.

In FIGS. 1-4, the embodiment illustrated may have pliable lengths 22a,b, and the lengths may meet at an end 26 opposite the attachments points such that the retainer 20 may form a U-shaped extension from the connector housing 18. Formed within the center of the U-shaped retainer 20 may be an opening or slot 28. The positioning of slot 28 may allow attachment points 24a,b to be on generally opposites of the connector housing 18. This position allows the cable 14 at the cable end 16 to be partially nestled within the slot 28 between lengths 22a,b. This nestling provides for a more streamlined physical arrangement for the cable management system 10 and may help maintain the retainer 20 in an unobtrusive position while not used to retain the cable 14.

A user may also fold the retainer 20 along a vertical axis, generally parallel to cable 14, to further keep the retainer 20 out of a user's way. If a user's folds the retainer 20 this way, lengths 22a and 22b may be manipulated to rotate around cable 14 to further keep the retainer 20 out of a user's way while the user, for example, listens to music. In this position, retainer end 26 may be wrapped around the cable 14 and held out of the way. Once the user finishes listening to music, the retainer 20 may be straighten to the extended position of FIG. 2 or may be further manipulated to secure the cable 14 (see movement arrow C).

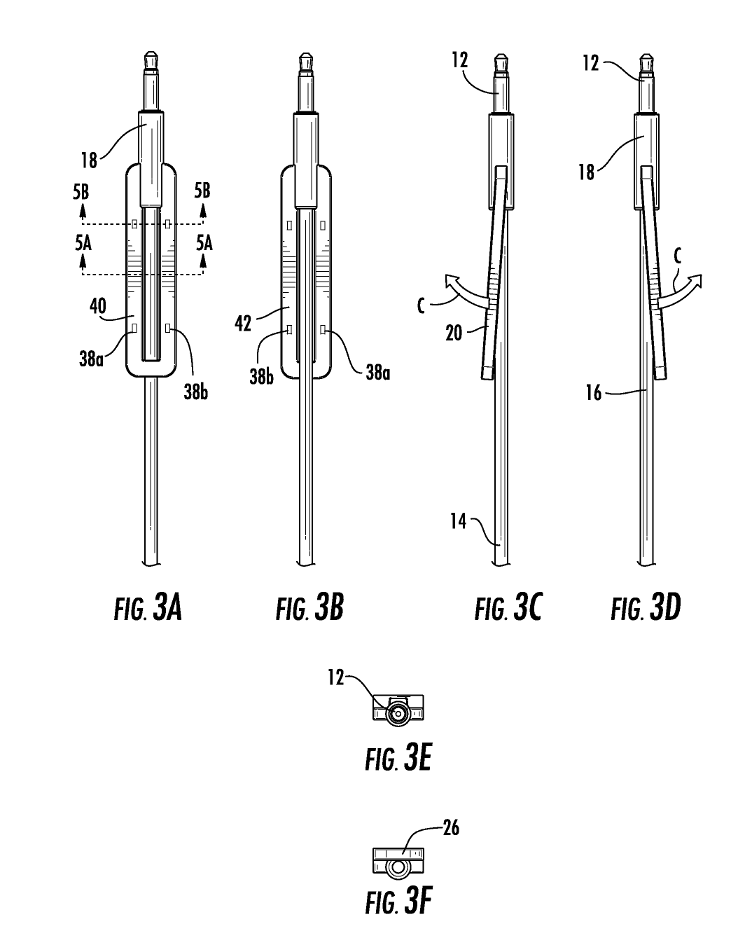

FIGS. 3a-f are views from the front, rear, side, opposing side, top, and bottom respectively, of the cable management system as illustrated in FIG. 2. FIG. 3a, a front view of the cable management system, includes cross-sectional lines 5A-5A and 5B-5B, where said cross-sections are shown in detail in FIGS. 5a and 5b.

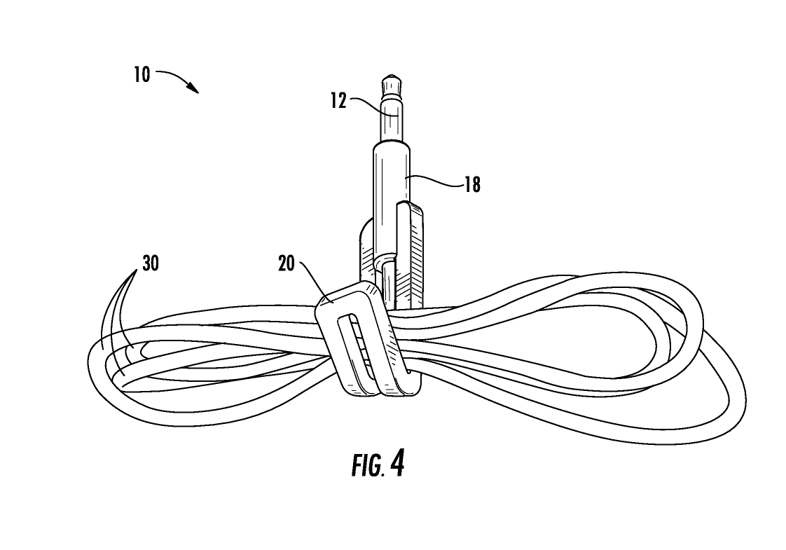

FIG. 4 illustrates an embodiment of the cable management system in use by a user to retain a cable. In the embodiment illustrated in FIG. 4, the user is retaining an audio cable; however, this method of retaining is not limited to use with audio cables. A user, wishing to neatly organize and wind a cable up, may wrap the cable 14 unto itself into overlapping bights 30 as illustrated. To maintain the cable 14 in this compact bundled state, a user may use the retainer 20 to hold the bights in place. The retainer 20 can be manipulated by the user straight up and around (as indicated by the direction of Arrow C in FIG. 2) or twisted up and to the left or the right to retain a wound up cable. The malleable retainer 20 may be manipulated to wrap around or be twisted over the bundled cable 14. The retainer 20 may maintain its shape and position while cinched around the cable 14 holding the cable in place and preventing it from unraveling.

The retainer 20 illustrated in FIGS. 1-4, may provide a more secure means to retain a coiled or wrapped cable as a result of the U-shaped structure. Having two lengths 22a,b may provide a wider contact patch for securing the cable bights 30 while also providing additional lateral rotational support so that the bights 30 of cable 14 cannot easily slip out of their retained position as illustrated in FIG. 4. Once a user wishes to release the cable 14, the user may simply straighten retainer 20, allowing the cable 14 to unwind in a controlled and untangled manner.

The retainer 20 may be formed with a malleable interior core 32, such as one or more metal wires 33 that will retain its shape when manipulated. The retainer 20 may be coated and finished with an outer surface material 34, such as plastic, silicone or TPU over the interior core 32. This treatment may give the retainer 20 a finished and integrated look with the connector housing 18 and/or the cable 14.

FIGS. 5a and 5b illustrate cross-sections of retainer 20 taken across lines 5A-5A and 5B-5B in FIG. 3a. FIGS. 5a and 5b illustrate a retainer 20 comprising two malleable wires 33a and 33b for its interior core 32. Forming the malleable interior core 32 of retainer 20 with two wires 33a,b may also provide the retainer 20 greater stability in retaining a coiled or wrapped cable. Two wires 33,a,b may also increase how secure the retainer 20 is in retaining a cable 14 because of the added strength of an additional wire 33. Similarly, it may also provide even more lateral rotational support so that the bights 30 of cable 14 cannot easily slip out of their retained position.

FIG. 5a, taken across cross-sectional line 5A-5A, illustrates a cross-sectional view of retainer 20 which may have an outer material 34 with a front surface 40 and rear surface 42. The cross-sectional view of FIG. 5a shows an example of the retainer 20 having two malleable wires 33a and 33b for its interior core 32. FIG. 5b is taken across a different line (cross-sectional line 5B-5B) of the same retainer illustrated in FIG. 5a. The cross-sectional view of FIG. 5b crosses the dimples 38 that may be found in the front and rear surfaces 40,42 of the retainer 20. The dimples 38a and 38b allow outer material 34 to form two channels in the inner core 32 for the malleable wires 33a and 33b to be contained within. These channels 38a and 38b may allow wires 33a,b to remain in place within the retainer despite the forces exerted on the wires by extreme or repeated manipulation of the retainer 20 by a user. This may increase the rigidity of the retainer 20 and the security of a retained cable 14.

The cable management system 10 may be part of a system of audio output devices. For example, the cable 14 may be an audio cable having male audio connectors on each end. One end may connect to a music source, such as an mp3 player via an audio input jack on the music source device (not shown). Music output devices, such a headphones, earphones, or stand alone or portable speakers may also be provided with an appropriate female audio input jack. Each one may be capable of being connected to the other end of the cable 14. A user could then have multiple music output devices at her disposal, yet may only be required to have and to transport a single cable 14 for use with each. Because cable 14 may have retainer 20 integral to the cable management system 10, a user can store and carry the cable 14 with ease and untangled convenience.

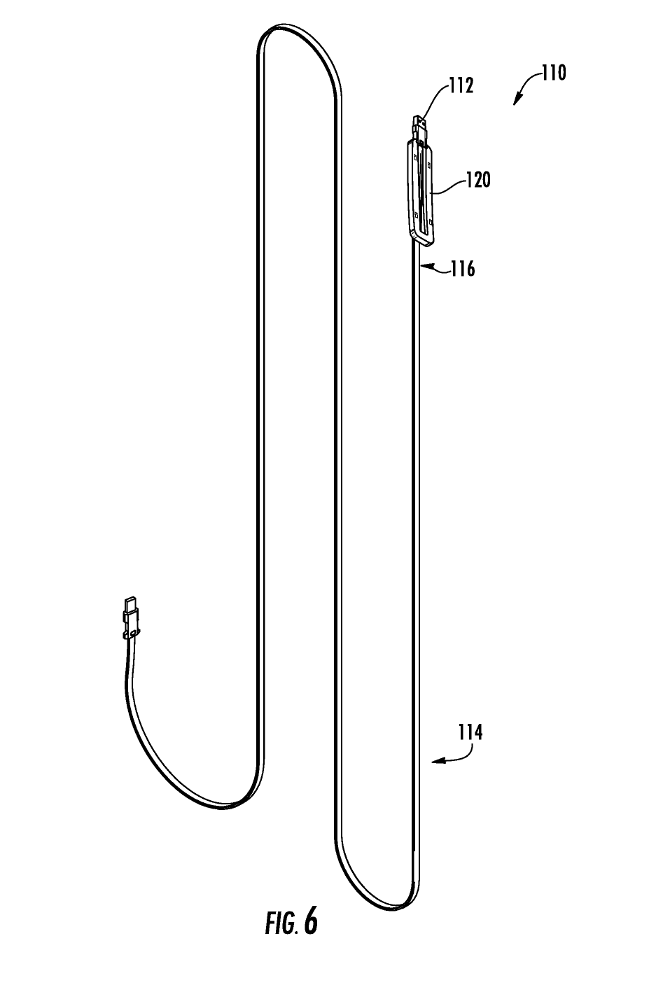

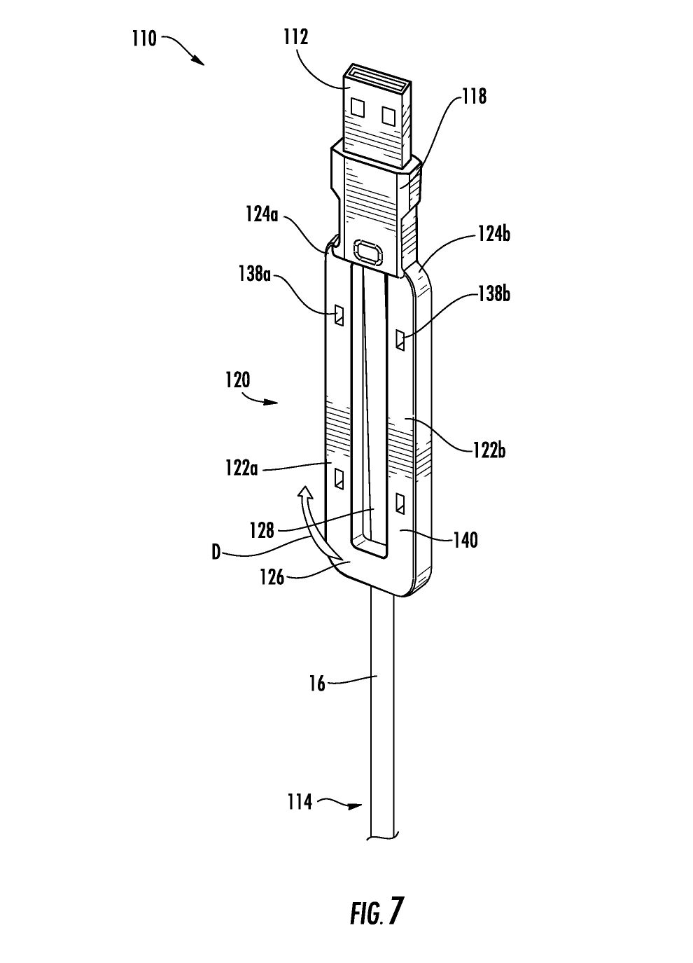

FIG. 6 is a perspective view of a cable management system 110 applied to a USB cable. FIG. 7 is an enlarged perspective view of the cable end 116 of a USB cable illustrating the cable management system 110 in greater detail. The USB cable can be USB 1.0, 2.0, 3.0 or a future iteration of the USB standard. The cable connector can be standard USB, micro USB, a mini USB, or any other present or future standardized connection to connect to an appropriate USB jack. A USB connector may be used to charge a smartphone or to transmit data. The cable or cable connector may be any other standardized or proprietary cable or cable connector known in the art for use with any other standardized or proprietary cable or cable connector in the art. The invention is not limited to USB connections, but any known or future connection for data transmission of power charging is contemplated.

The cable management system 110 of FIGS. 6-9 may be integral with a cable connector 112 which may be fixed to a cable 114 at an end of the cable 116. The cable connector 112 may be housed in a connector housing 118. Extending from the connector housing 118 may be a malleable cable retainer 120. The cable retainer 120, which may be integral to a connector housing 118 of the cable connector 112, may be disposed on the connector housing 118 in a position to not interfere with a user's ability to connect the cable 114 with the cable connector 112. The cable retainer 120 may also be disposed to extend generally away from the cable connector 112 and positioned generally parallel and adjacent to the cable 114 at the cable end 116 when not in use to restrain the cable 114. This positioning may help keep the retainer 120 out of a user's way and prevent it from getting snagged during use.

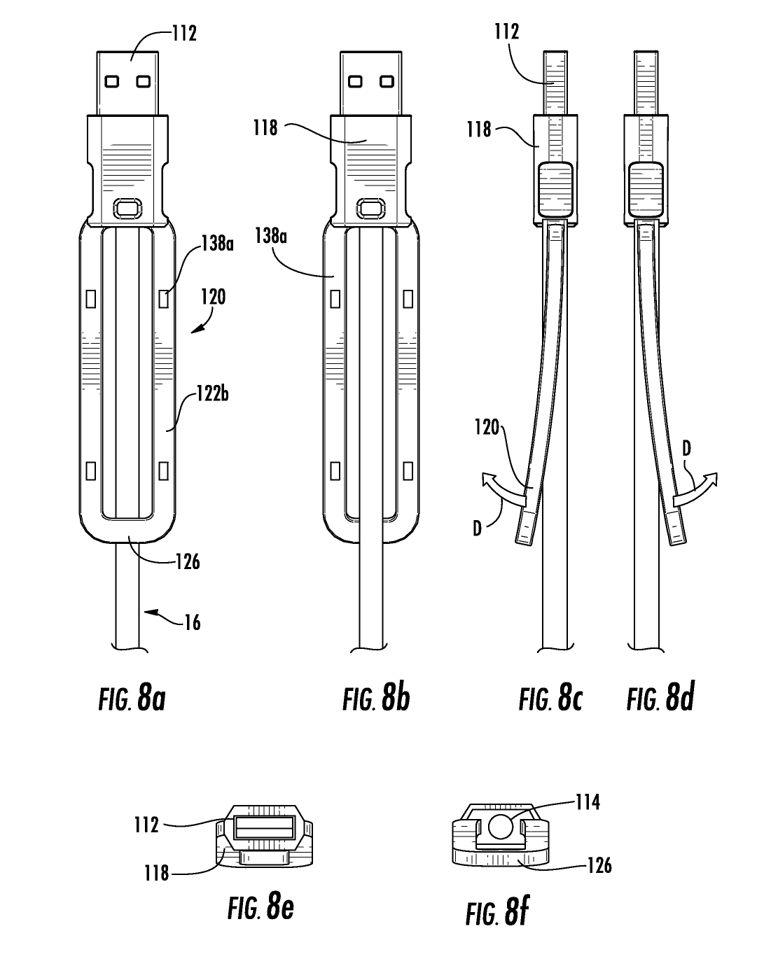

FIGS. 8a-f are views from the front, rear, side, opposing side, top, and bottom respectively, of the cable management system as illustrated in FIG. 7.

In the embodiments of the cable management system illustrated in FIGS. 6-9, retainer 120 may include two length 122a,b which are attached to the connector housing 118 at two points 124a,b on the connector housing 118. In closer proximity to attachments points 124a,b, the lengths may be more rigid, while the lengths may be more pliable further from the attachments points 124a,b. Lengths 122a,b may have one or more dimples or recesses 138a,b on a front 140 or rear 142 facing surface of retainer 120. As illustrated in FIGS. 5a and 5b and discussed supra, the dimples may serves to hold internal malleable wires in place within channels formed by the dimples, inside a retainer 120.

The pliable lengths 122a,b may meet at an end 126 opposite the attachments points such that the retainer 120 may form a U-shaped extension from the connector housing 118. Formed within the center of the U-shaped retainer 120 may be an opening or slot 128. The positioning of slot 128 may allow attachment points 124a,b to be on generally opposites of the connector housing 118. This position allows the cable 112 at the cable end 114 to be slightly nestled within the slot 128 between lengths 122a,b. This partial nestling provides for a more streamlined physical arrangement for the cable management system 110 and may help maintain the retainer 120 in an unobtrusive position while not used to retain the cable 114. The retainer 120 may also be folded by a user along a vertical axis, generally parallel to cable 114, allowing retainer end 126 to wrap around cable 114 to further keep the retainer 120 out of a user's way.

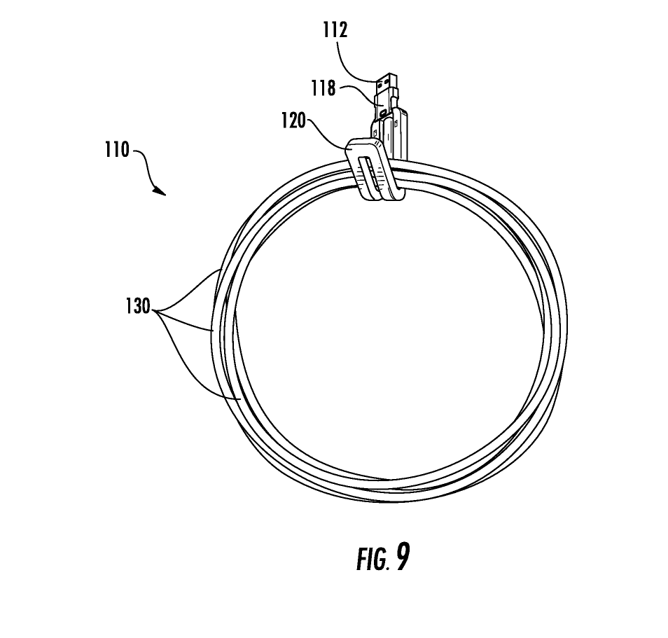

FIG. 9 illustrates the cable management system 110 in use by a user to retain a cable 114. In the embodiment illustrated in FIG. 9, the user is retaining a USB cable; however, this method of retaining is not limited to use with a particular type of cable. A user, wishing to neatly organize and wind a cable up may wrap the cable 114 into overlapping coils 130 as illustrated. To maintain the cable 114 in this compact coiled state, a user may use the retainer 120 to hold the coils in place. The malleable retainer 120 may be manipulated by a user to wrap around or be twisted over the coiled cable 114. The retainer 120 can be manipulated by the user straight up and around (as indicated by the direction of Arrow D in FIG. 7) or twisted up and to the left or the right to retain a coiled cable 114. The retainer 120 will maintain its shape and position cinched around the cable 114 holding the cable in place and prevent it from unraveling. Once a user wishes to release the cable 114, the user may simply straighten retainer 120, allowing the cable 114 to unwind in a controlled and untangled manner.

Although the illustrations show a bundled cable (FIG. 4) and a coiled cable (FIG. 9) being held by a malleable retainer (20, 120), this description imposes no limitations on how a cable is gathered, coiled or bundled before being retained by the cable management system. Certain cables may have greater relative flexibility or size and may lend themselves to different gathering techniques. Similarly, no limitations are intended in any direction that a user can manipulate the retainer 20,120 to secure a cable 14,114.

In another embodiment of a cable management system, the cable management system may be integral with a cable connector which is not permanently fixed to a cable. The cable connector may be a male or female plug for connection to an appropriate male or female opposite connection of a plug, jack, receptacle, or socket, of an electronic device or of other cable connector. Connector housing may also have, on the opposite end of cable connector a male or female jack, receptacle, or socket for connection with a cable. The cable connector may be any other standardized or proprietary connector known in the art for use with any other standardized or proprietary cable in the art. This embodiment may allow a user to retrofit an existing cable with a cable management system so that the cable may be retained in a convenient organized manner.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed:

1. A cable management system comprising:
a cable comprising a flexible conductor, a first end and a second end, and a cable axis extending from said first and second ends when said cable is tautly extended;
a connector body coupled to said cable at said first end of said cable;
a securing member coupled to said connector body, said securing member comprising at least a first pliable length;
in a first position, said securing member is disposed to extend away from said connecter body in a direction adjacent to and generally parallel to said cable axis; and
in a second position, said securing member is disposed to secure said cable by wrapping around overlapping lengths of said cable.

2. The cable management system of claim 1, wherein said securing member is integral with said connecting body.

3. The cable management system of claim 1, wherein said securing member comprises at least a second pliable length.

4. The cable management system of claim 3, wherein said first and second pliable lengths are disposed on opposite sides of said cable axis and each extend away from said connecter body in a direction adjacent to and generally parallel to said cable axis in said first position.

5. The cable management system of claim 3, wherein said first and second pliable lengths are coupled to each other at point other than said attachment member.

6. The cable management system of claim 3, wherein a channel is formed between said first and second pliable lengths.

7. The cable management system of claim 6, wherein said channel is parallel to said cable axis in said first position.

8. The cable management system of claim 1, wherein said securing member coupled to said attaching member further comprises a least one rigid length disposed adjacent to said attaching member.

9. The cable management system of claim 8, wherein said securing member coupled to said attaching member further comprises a least a second rigid length, said first and second rigid lengths disposed on opposite sides of said attaching member.

10. The cable management system of claim 1, wherein said securing member is malleable.

11. The cable management system of claim 1, wherein said securing member comprises a malleable inner core and is covered in an outer layer.

12. The cable management system of claim 1, wherein said securing member retains its shape when manipulated by a user.

13. A cable management system comprising:
a cable comprising a flexible conductor, a first end and a second end, and a cable axis extending from said first and second ends when said cable is tautly extended;
a connector body coupled to said cable at said first end of said cable;
a malleable securing member integral with said connector body;
in a first position, said securing member is disposed to extend away from said connecter body in a direction adjacent to and generally parallel to said cable axis;
in a second position, said securing member is disposed to secure said cable by wrapping around overlapping lengths of said cable; and
wherein said securing member retains its shape when manipulated by a user.

14. The cable management system of claim 13, wherein said securing member comprises a U-shaped extension.

15. The cable management system of claim 13, wherein said securing member is attached to said connector body at points on opposite sides of said cable axis and extends away from said connecter body in a direction adjacent to and generally parallel to said cable axis in said first position.

16. The cable management system of claim 14, wherein a channel is formed within said U-shaped extension, wherein said channel is parallel to said cable axis in said first position.

17. The cable management system of claim 13, wherein said securing member comprises a malleable inner core and is covered in an outer layer.

18. The cable management system of claim 17, wherein said malleable inner core comprises more than one wire.

19. The cable management system of claim 17, wherein said securing member comprises at least one indentation to secure said malleable inner core.

20. A cable management system comprising:
a cable comprising a flexible conductor, a first end and a second end, and a cable axis extending from said first and second ends when said cable is tautly extended;
a connector body coupled to said cable at said first end of said cable;
a securing member integral with said connector body, said securing member comprising at least a two pliable lengths,
wherein said first and second pliable lengths are disposed on opposite sides of said cable axis and each extend away from said connecter body in a direction adjacent to and generally parallel to said cable axis in a first position;
wherein said first and second pliable lengths are coupled to each other at point other than said attachment member;
wherein said securing member is malleable and retains its shape when manipulated by a user;
wherein, in said first position, said securing member is disposed to extend away from said connecter body in a direction adjacent to and generally parallel to said cable axis; and
wherein, in a second position, said securing member is disposed to secure said cable by wrapping around overlapping lengths of said cable.
